(19) United States
(12) Patent Application Publication
(10) Pub. No.: US 2007/0089169 A1
(43) Pub. Date: Apr. 19, 2007

(54) SYSTEM AND METHOD FOR HARD DISK PROTECTION

(75) Inventor: Kun-Shan Chung, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,452

(22) Filed: Aug. 9, 2006

(30) Foreign Application Priority Data
Oct. 14, 2005 (CN) 200510100363.3

(51) Int. Cl. G06F 12/14

(52) U.S. Cl. 726/19

(57) ABSTRACT

A system for hard disk protection includes a computer. The computer includes a hard disk protection module, which includes: a verifying unit for determining whether a hard disk linked to the computer is locked, determining whether there is a generated password in a BIOS ROM of the computer, and determining whether an hard disk password setting in the hard disk is identical with the generated password or a factory default password stored in the BIOS ROM; a password reading unit for reading a factory default password or the generated password stored in the BIOS ROM, and reading an hard disk password setting in the hard disk; an unlocking unit for sending a request of unlocking the hard disk by the generated password or by the factory default password; and a password setting unit for writing the generated password to the hard disk to replace the hard disk password setting.

### DESCRIPTION

1. Field of the Invention

The present invention generally relates to systems and methods for protecting computer systems, and more particularly to a system and method for protecting hard disk of computers.

2. Description of Related Art

A computing system, such as a desktop-type personal computer, notebook computer or the like, provide security mechanisms. As an example of such a security mechanism, upon booting a computer system of a related art, a password entry prompt is displayed on a screen for a user to enter a password. The entered password is compared with a password previously defined by the user. An operating system of the computer system is accessible only when the entered password is valid. As a result, only an authorized user can gain access to the computer system.

However, the computer system of the related art employing such a security mechanism has a disadvantage: the security mechanism only protects access to the computer system disregarding data stored in the computer system, such as data in a hard disk as an auxiliary storage unit. Thus, when the hard disk is detached from the computer system of the related art with the above-described security mechanism, and then mounted to a different computer system, data such as important documents etc. stored in the hard disk may be easily exposed.

What is needed, therefore, is a system and method for setting a generated password for valid hard disks linked to a computer, thus realizing protecting data in valid disks of the computer more independently and effectively.

### SUMMARY OF INVENTION

A system for hard disk protection in accordance with a preferred embodiment is provided. The system includes a computer, and the computer includes a hard disk protection module, which includes: a verifying unit for determining whether a hard disk linked to the computer is locked, determining whether there is a generated password in a BIOS ROM of the computer, and determining whether an hard disk password setting in the hard disk is identical with the generated password or a factory default password stored in the BIOS ROM; a password reading unit for reading the factory default password or the generated password stored in the BIOS ROM, and reading the hard disk password setting in the hard disk; an unlocking unit for sending a request of unlocking the hard disk by the generated password or by the factory default password; and a password setting unit for writing the generated password to the hard disk to replace the hard disk password setting, if the hard disk password setting in the hard disk is identical with the factory default password.

A computer-based method for hard disk protection in accordance with a preferred embodiment is provided. The method can set a generated password for valid hard disks linked to a computer, which includes the steps: (a) checking whether a hard disk linked to a computer is locked; (b) checking whether there is a generated password in a BIOS ROM of the computer, if the hard disk is locked; (c) reading the generated password, if there is a generated password stored in the BIOS ROM; (d) sending a request of unlocking the hard disk by the generated password; (e) determining whether an hard disk password setting in the hard disk is identical with the generated password; (f) reading a factory default password in the BIOS ROM, if the hard disk password setting in the hard disk is not identical with the generated password; (g) sending a request of unlocking the hard disk again by the factory default password; (h) determining whether the hard disk password setting in the hard disk is identical with the factory default password; and (i) writing the generated password to the hard disk to replace the hard disk password setting, if the hard disk password setting in the hard disk is identical with the factory default password.

In summary, the system and method can secure data in valid disks of a computer more independently and strictly. Since the system automatically check hard disks linked to the computer, so that users needn't to input any password, and the generated password is difficult to steal by persons who have evil intentions.

Other advantages and novel features of the embodiments will be drawn from the following detailed description with reference to the attached drawings, in that:

### BRIEF DESCRIPTION OF DRAWINGS

FIG. 1 is an illustration of a system environment incorporating the present invention;

FIG. 2 is a diagram of function units of a preferred system for hard disk protection; and

FIG. 3 is a flowchart of a preferred method for hard disk protection.

### DETAILED DESCRIPTION

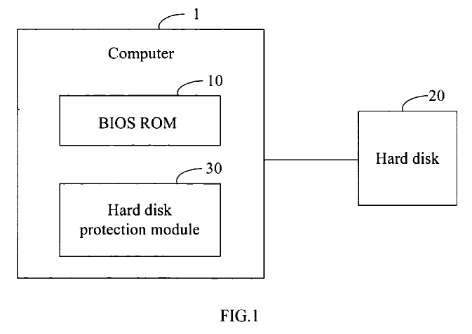

FIG. 1 is an illustration of a system environment incorporating one embodiment of the present invention. The system includes a computer 1 and at least one hard disk 20. The computer 1 includes a read-only memory (ROM) containing a basic input/output system (BIOS) (hereinafter, “the BIOS ROM 10”), and a hard disk protection module 30. The computer 1, which is typically a personal computer (PC), may further include a plurality of units known in the art, such as a central processing unit (CPU) and a southern bridge chip (not shown). The hard disk 20 is linked to the computer 1. The BIOS ROM 10 stores a factory default password and a generated password.

When the computer 1 is powered on, the hard disk protection module 30 automatically scans the hard disk 20 for a password setting. If the hard disk 20 has no password setting therein, or if a hard disk password setting of the hard disk 20 is different from the generated password or the factory default password stored in the BIOS ROM 10, it can be denoted the hard disk 20 does not match the computer 1. The hard disk 20 is considered an invalid hard disk. Otherwise, if the hard disk password setting of the hard disk 20 is the same as the generated password or the factory default password, it indicates that the hard disk 20 is a matched data storage device for the computer 1. Furthermore, if the hard disk password setting is the same as the factory default password stored in the BIOS ROM 10, the hard disk protection module 30 replaces the hard disk password setting in the hard disk 20 with the generated password. When the hard disk 20 is removed from the computer 1 and assembled in another computer system, the hard disk 20 becomes locked, this is because the generated password of the hard disk 20 is only known by the computer 1. It is difficult to decipher the generated password, making the data in the hard disk 20 is inaccessible.

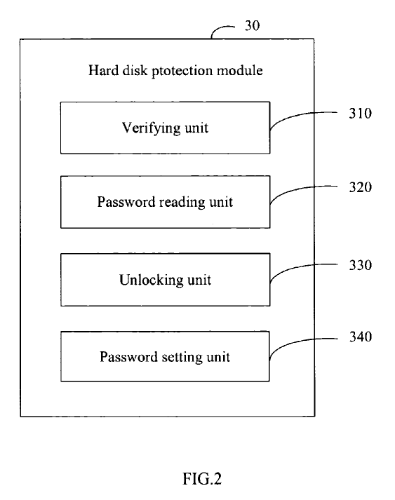

FIG. 2 is a schematic diagram of function units of the hard disk protection module 30. The hard disk protection module 30 includes: a verifying unit 310, a password reading unit 320, an unlocking unit 330, and a password setting unit 340. The verifying unit 310 is used for determining whether the hard disk 20 linked to the computer 1 is locked, determining whether there is a generated password stored in the BIOS ROM 10, and determining whether a hard disk password setting in the hard disk 20 is identical with the generated password or the factory default password stored in the BIOS ROM 10. The password reading unit 320 is used for reading the factory default password or the generated password stored in the BIOS ROM 10, and reading the hard disk password setting in the hard disk 20. The unlocking unit 330 is used for sending a request for unlocking the hard disk 20 on the basis of the generated password or the factory default password. The password setting unit 340 is used for setting the hard disk password setting in the hard disk 20 with the generated password if the hard disk password setting in the hard disk 20 is identical with the factory default password.

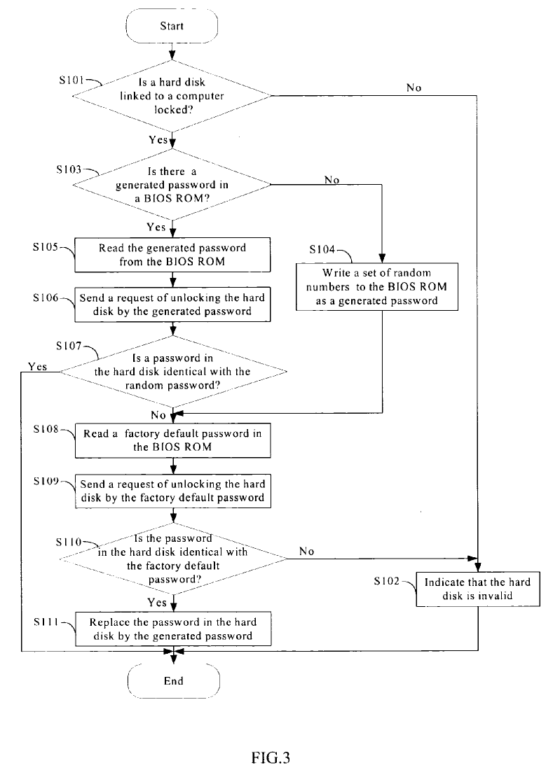

FIG. 3 is a flowchart of a preferred method for hard disk protection. In step S101, the verifying unit 310 determines whether the hard disk 20 is locked. If the hard disk 20 is not locked, in step S102, the verifying unit 310 indicates that the hard disk 20 is invalid (valid hard disks of the computer are locked by the factory default password before use, so a unlock hard disk coupled to the computer is considered invalid.). Otherwise, if the hard disk 20 is locked, in step S103, the verifying unit 310 determines whether the generated password exists in the BIOS ROM 10. If there is no generated password stored in the BIOS ROM 10, in step S104, the password reading unit 320 reads a set of random characters generated by the computer 1 to be used as a generated password, the password setting unit 340 writes the generated password to the BIOS ROM 10, then the procedure goes directly to step S108 described later.

If the generated password is in the BIOS ROM 10, in step S105, the password reading unit 320 reads the generated password. In step S106, the unlocking unit 330 sends a request for unlocking the hard disk 20 with the generated password. In step S107, the verifying unit 310 determines whether the hard disk password setting in the hard disk 20 is identical with the generated password. If the hard disk password setting is identical with the generated password, the procedure ends.

If the hard disk password setting is not identical with the generated password, in step S108, the password reading unit 320 reads the factory default password in the BIOS ROM 10. In step S109, the unlocking unit 330 sends a request for unlocking the hard disk 20 with the factory default password. In step S110, the verifying unit 310 determines whether the hard disk password setting in the hard disk 20 is identical with the factory default password. If the hard disk password setting is identical with the factory default password, indicating that the hard disk 20 is the valid hard disk configured for the computer 1, then in step S111, the password setting unit 340 sets the hard disk password setting with the generated password in the hard disk 20. Otherwise, if the hard disk password setting is not identical with the factory default password, the procedure returns to step S102 described above.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for hard disk protection comprising a computer, the computer comprising a hard disk protection module, the hard disk protection module comprising:
a verifying unit for determining whether a hard disk linked to the computer is locked, determining whether there is a generated password in a BIOS ROM of the computer, and determining whether a hard disk password setting in the hard disk is identical with the generated password or a factory default password stored in the BIOS ROM;
a password reading unit for reading the factory default password or the generated password stored in the BIOS ROM, and reading the hard disk password setting in the hard disk;
an unlocking unit for sending a request for unlocking the hard disk using the generated password or the factory default password; and
a password setting unit for writing the generated password to the hard disk replacing the hard disk password setting if the hard disk password setting in the hard disk is identical with the factory default password.

2. The system according to claim 1, wherein the verifying unit is further used for giving an indication when the hard disk is invalid.

3. The system according to claim 2, wherein a valid hard disk means the hard disk password setting in the hard disk is identical with the factory default password or the generated password stored in the BIOS ROM.

4. A computer-based method for hard disk protection, the method comprising the steps of:
checking whether a hard disk linked to a computer is locked;
checking whether there is a generated password in a BIOS ROM of the computer if the hard disk is locked;
reading the generated password if there is a generated password stored in the BIOS ROM;
sending a request of unlocking the hard disk with the generated password.

5. The method according to claim 4, further comprising the step of determining whether an hard disk password setting in the hard disk is identical with the generated password.

6. The method according to claim 5, further comprising the step of reading a factory default password in the BIOS ROM if the hard disk password setting in the hard disk is not identical with the generated password.

7. The method according to claim 6, further comprising the step of sending a request of unlocking the hard disk again with the factory default password.

8. The method according to claim 7, further comprising the step of determining whether the hard disk password setting in the hard disk is identical with the factory default password.

9. The method according to claim 8, further comprising the step of writing the generated password to the hard disk replacing the hard disk password setting if the hard disk password setting in the hard disk is identical with the factory default password.

10. The method according to claim 9, further comprising the step of writing a set of random numbers to the BIOS ROM to be used as a generated password, if a generated password stored in the BIOS ROM does not exists; and
going to the step of reading the factory default password in the BIOS ROM.

11. The method according to claim 6, further comprising the step of:
indicating that the hard disk is invalid, if the hard disk password setting in the hard disk is not identical with the factory default password.

12. The method according to claim 4, further comprising the step of:
indicating that the hard disk is invalid, if the hard disk linked to the computer is checked as unlocked.
